(19) United States
(12) Patent Application Publication
(10) Pub. No.: US 2017/0052907 A1
(43) Pub. Date: Feb. 23, 2017

(54) SYNCHRONIZED HARDWARE-BASED SECURITY FOR A COMMUNICATION SYSTEM

(71) Applicant: Oblivion Labs,Inc., Santa Rosa, CA (US)

(72) Inventors: Steven Charles Price, JR., Santa Rosa, CA (US); Weston Raymond Alameida, Sebastopol, CA (US)

(21) Appl. No.: 15/239,380

(22) Filed: Aug. 17, 2016

Related U.S. Application Data
(60) Provisional application No. 62/205,957, filed on Aug. 17, 2015.

(51) Int. Cl. G06F 12/14; G06F 21/78; G06F 21/72

(52) U.S. Cl. CPC G06F 12/1408; G06F 21/72; G06F 21/78; G06F 2212/1052

(57) ABSTRACT

An improved apparatus, method and computer-readable storage medium are provided for implementing a secured communication system via synchronized hardware-based security. The present disclosure thus includes, without limitation, various example implementations directed toward secured data transmission reliant on hardware-based encryption and/or decryption methods. The secured communication system may provide secure real-time communications over networks, such as, but not limited, to computer networks, even when the networks being used are inherently insecure.

### CROSS-REFERENCE TO RELATED APPLICATION(S)

The present application claims priority to U.S. Provisional Patent Application No. 62/205,957, entitled: Synchronized Hardware-Based Security for a Communication System, filed on Aug. 17, 2015, the content of which is incorporated herein by reference.

### TECHNOLOGICAL FIELD

The present disclosure relates generally to implementing secured communication between two networked or otherwise connected devices and, in particular, to implementing a secured communication system via synchronized, paired hardware-based security.

### BACKGROUND

Known security techniques are available that seek to provide secure, real-time communications over networks. However, it is common for at least some of the known security techniques to fail when the networks being used are inherently insecure, or when the security techniques are poorly implemented or otherwise utilize vulnerable techniques or components. Therefore, a need exists for a secured communication system that enables encrypted data transmission via synchronized hardware-based encryption.

### BRIEF SUMMARY

Example implementations of the present disclosure are directed to an improved apparatus, method and computer-readable storage medium for providing a secured communication system via synchronized hardware-based security. The present disclosure thus includes, without limitation, various example implementations directed toward secured data transmission reliant on hardware-based encryption and/or decryption methods. The secured communication system may provide secure real-time communications over networks, such as, but not limited to, computer networks, even when the networks being used may be inherently insecure.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as being combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE DRAWING(S)

Having thus described example implementations of the disclosure in general terms, reference will now be made to the accompanying drawings, which are not necessarily drawn to scale, and wherein:

FIG. 1 is a diagram illustrating a secured communication system and other network devices, according to example implementations of the present disclosure;

FIG. 2 is a block diagram of a security module in accordance with an example implementation;

FIG. 3 is a diagram illustrating a keystream seed update in accordance with an example implementation;

FIG. 4 is a diagram illustrating paired security modules in accordance with an example implementation;

FIGS. 5A-5C illustrate Ethernet devices incorporating security modules or portions thereof, in accordance with example implementations;

FIG. 6 is a schematic illustrating aspects of a security module in accordance with an example implementation;

FIG. 7 is a flow diagram illustrating various operations of a method for initiating a connection for data transmission, in accordance with an example implementation;

FIG. 8 is a flow diagram illustrating various operations of a method of data encryption, in accordance with an example implementation;

FIG. 9 is a flow diagram illustrating various operations of a method of data decryption, in accordance with an example implementation; and

FIG. 10 illustrates an apparatus according to some example implementations.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

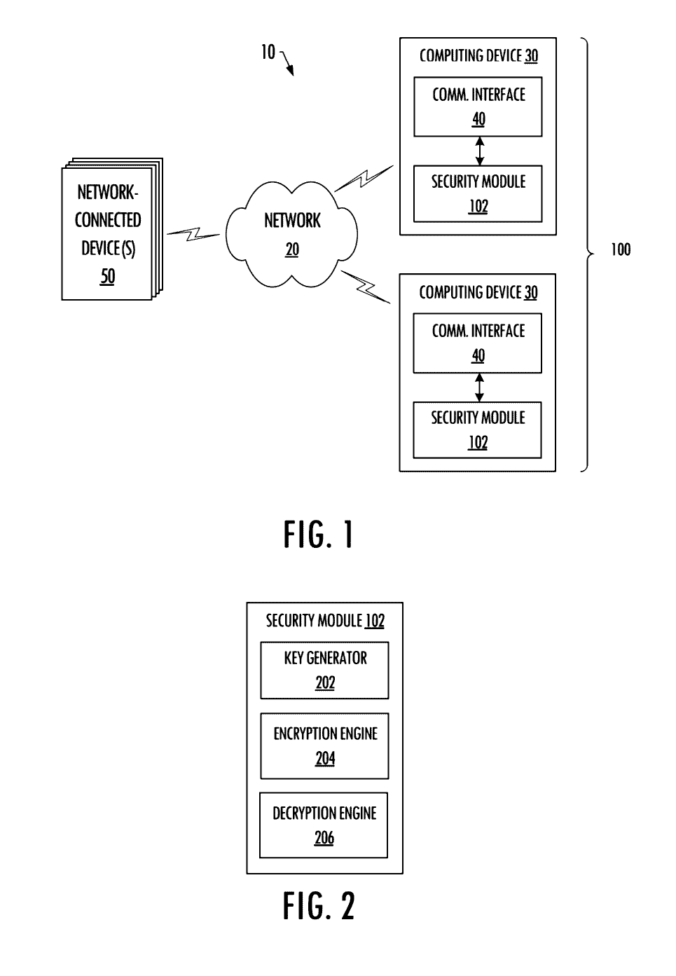

Example implementations of the present disclosure are generally directed to implementing secured communication between two networked or otherwise connected devices (e.g., computing device) and, in particular, to implementing a secured communication system via synchronized, paired hardware-based security modules. FIG. 1 illustrates a communication system 10 over which one or more computing devices may securely communicate according to example implementations of the present disclosure. The communication system or a portion thereof may be a secured communication system 100 for providing secure, real-time communication over at least one network, such as, but not limited to, network 20, as will be discussed in greater detail below. The secured communication system may include one or more of each of a number of subsystems (each an individual system) such as, for example, one or more computing devices 30 each having a respective communication interface 40 therein. The computing devices may be coupled, by a wired or wireless connection, over one or more networks 20 in which at least two computing devices may further include a respective security module 102 coupled to a communication interface to enable secured communication between the computing devices.

In some examples, a communication interface 40 and security module 102 may be integrated into a single apparatus configured to perform the operations of both the communication interface and security module, and this communication interface may be in addition to or in lieu of any other communication interfaces with which the computing device 30 may be equipped. In some examples, the integrated apparatus may itself include a pair of communication interfaces, one to couple the security module to the computing device, and another to couple the computing device with the security module over the network(s) 20 with another computing device having an appropriate communication interface and security module, which may or may not be itself integrated into a single apparatus.

The security modules 102 may be paired with one another to implement synchronized hardware-based encryption and/or decryption of data transmitted between at least the two computing devices 30 such that the computing devices are enabled to securely communicate over the network 20, even when the network may be inherently insecure or susceptible to vulnerabilities, such as due to other network connected devices 50. The network-connected devices may include one or more, such as hundreds or thousands, of electronic communications devices, which may be conventional. Each computing device and/or network-connected device may be embodied as any suitable computing device that may be configured to communicate with one or more other communication devices via a network, as described further herein. By way of non-limiting example, each electronic communication device may be embodied as a desktop computer, a netbook, a laptop computer, a cellular phone, such as a smart phone device, a personal digital assistant (PDA), a tablet computing device, a media player device, a portable game device, automated teller machine (ATM), some combination thereof, or the like.

The network 20 may be any suitable digital communications infrastructure. For example, the network may be embodied as one or more wireless networks, such as one or more cellular networks, one or more wireless local area networks (WLANs), and/or the like; one or more wired networks; or some combination thereof In some example implementations, the network may comprise at least a portion of the Internet. For example, the network may be embodied as, or comprise, one or more suitable communication networks, such as, but not limited to, the Internet, cable television networks, cellular data networks, and/or the public switched telephone network. Devices within the communication system 10 (e.g., the computing devices 30 and network-connected devices 50) may be configured to access the network via any of a variety of access networks. For example, each computing device 30 and network-connected device 50 may be configured to access the communications network via a cellular access network and/or via a WLAN. As another example, one or more further computing devices within the system may be configured to access the communications network via a wired access network, such as via a cable system, phone system, or other wired access system that may be implemented by a network service provider. It will be appreciated, however, that any available access network may be used by devices of the communication system to access the communications network in accordance with various implementations.

In one example implementation, the security modules 102 may be embodied as a specific-purpose integrated circuit such as an application-specific integrated circuit (ASIC). The security modules may be configured to allow adequate computation speed to facilitate data encryption in high-traffic scenarios. Data encryption within the secured communication system 100, via the security modules, may be accomplished through a proven security key-based encryption scheme such as Advanced Encryption Standard (AES). For example, the security modules may be configured to implement data encryption at a substantially rapid speed to facilitate real-time encryption of network traffic across the network 20 in instances in which the network traffic may be communicated at a rate that is faster than a standard encryption rate and/or the network traffic includes a substantially large amount of data.

In one example implementation, information programmed within the paired security modules 102 may be identical and only known to each security module; although, such information may exclude identifiers that include information for individually identifying each corresponding security module in the pair. The security modules may be configured such that there is no physical capability to externally access the identical information programmed within the security modules. In one example implementation, once programmed, the only external influence on the security modules' functionality in relation to security information is the ability to erase and/or overwrite the information within each security module. The ability to erase and/or overwrite the information within each security module may only be executed by an authorized party in physical possession of the security module.

In one example implementation, the security modules 102 may be configured such that an unauthorized party is unable to reprogram and/or externally tamper with the paired security modules. This feature may advantageously prevent a non-paired security module from being reprogrammed to replicate the internal state of a security module within an existing pair, so as to prevent the non-paired security module from potentially overriding the data stream of the replicated security module within the pair. Accordingly, unauthorized reprogramming of the security modules may be prevented by securing the internal state of the security modules and obfuscating the programming process for the security modules.

In one example implementation, the security modules 102 may be configured such that the functionality to read and/or output information regarding the internal state of the security module is disabled, thereby preventing unauthorized parties from acquiring pertinent security information from within the security module. In one implementation in which each security module may be or include an ASIC, the security module may be configured such that the accessible pins of the ASIC are unable to render insight regarding the internal state of the security module. In such an implementation, the ASIC may be included within an Ethernet device. The ASIC may be programmed using a specialized coded input to prevent unauthorized reprogramming. In particular, high and low signals may be applied to the external programming pins of the ASIC, at a required predetermined value, thereby activating digital logic that disables a corresponding Ethernet controller and circuitry for security key generation to re-route the external Ethernet pins to the programming logic. In this state, the initial state may be written to the internal memory via the Ethernet pins. As such, the security modules may also be configured to provide physical protection against tampering.

According to example implementations, the security modules 102 may be two uniquely paired devices configured to create a unique, secure, bidirectional communications data streams across the network 20 between the communication interfaces 40 of the computing devices 30. The security modules may be included in and/or operatively coupled to a respective communication interface and configured to autonomously encrypt and decrypt packet-based digital communications without, for example, the need for transmission or sharing of security information (e.g., security keys).

FIG. 2 more particularly illustrates a security module 102 of the secured communication system 100 of FIG. 1. The security module may include one or more of each of any of a number of different subsystems (each an individual system) for performing one or more functions or operations to facilitate providing secured data transmission. As shown, for example, the security module may include a key generator 202, an encryption engine 204 and/or a decryption engine 206. It should be understood that while the key generator, encryption engine, and decryption engine are shown as part of the security module, one or more of the respective systems may instead be separate from but in communication with the security module or even the communication interface 40 and computing device 30. Further, it should be understood that one or more of the subsystems may function or operate as a separate system without regard to others of the subsystems. And it should be understood that the security module may include one or more additional or alternative subsystems than those shown in FIG. 2.

As explained in greater detail below, the key generator 202 may be generally configured to generate security keys for use in data encryption and/or decryption. The encryption engine 204 may be generally configured to encrypt data received from a private communication interface prior to being transmitted via a public communication interface. The decryption engine 206 may be generally configured to decrypt information received from a public communication interface prior to being received via a private communication interface.

In one example implementation, two paired security modules 102 may comprise matching security information (e.g., security keys), thereby enabling secured data transmission without the need to transmit the security keys or associated security information across the network 20. The respective key generators 202 of the security modules may be configured to execute a self-contained autonomous method for perpetually generating new security keys through several multi-order derivative random number generator and/or hashing functions used for varied intervals of time during communication. As used herein, a series of random security keys produced by the key generator may be simply referred to as a “keystream.” As also used herein, the term “random” should be construed to encompass not only true random but also pseudo-random. It should therefore be understood that the random number generator of example implementations may refer to a random number generator configured to generate true random numbers, or a pseudo-random number generator configured to generate pseudo-random numbers.

In one example implementation, the autonomous security key generation may be provisioned by the key generator 202. The key generator may be configured to operate such that it is restrictively difficult to determine the value of any security key, or allow for any potential advantage of predicting future security keys, given the value of one or more subsequent security keys. This functionality may be implemented based at least in part on one or more of the following, including, but not limited to excluding bits in a security key from being utilized in the calculation of the next security key, and utilizing the variables in a security key to determine security key generation logic for generating variables to create a subsequent security key. In one example, variables may be introduced during the operation of the key generator to add entropy to the security key lineage. This feature may be advantageous as it results in diversifying the unique relationship between security modules over time. The addition of entropy may be utilized for both volatile and nonvolatile security key generation.

In one example implementation, the addition of entropy to the security key lineage resultantly creates a communication system 100, wherein given the current security key and/or the function used to create it, a prohibitive amount of unknown variables exist that hinder any attempts to determine past security keys. Traditionally, due to the deterministic nature of pseudo-random number generators, it is possible to predict future security keys given the logic used for their generation and the starting point (e.g., security key generation seed). Accordingly, the security module 102 may be configured to prevent prediction of the security key lineage based on one or more processes that advantageously rely on the existence of information being inherently available to both security modules of a pair of security modules.

In one example implementation, the key generator 202 may be configured to protect the security key generation seed. The key generator may be configured such that no circuitry or functionality exist within the security module 102 to extract the contents of its memory, thereby preventing the seed information from being recorded during the programming and pairing of chips. The key generator may also be configured so that, over time there are changes to the parameters used for generating the next connection initiation information. For example, the length of each keystream may be volatile such that the key lineage is unpredictable, and the starting point for any communication session is not directly related to the starting point of the previous or next session. The number of times each of the keystreams within the security modules volatile lineage have terminated is also used when generating new security key information.

In some examples, a hardware random number generator (true random number generator—TRNG) may be incorporated to trigger an intentional (early/premature) termination of a key stream lineage. By electing a keystream at random using truly random information, entropy is incorporated into current and future security information. This limits/removes/mitigates the inherently predictable nature of the system's pseudo-random processes. Without this, entropy would be limited by and correlated amongst all active keystreams on connection or power loss.

The system's inherent failure detection and recovery mechanisms allow entropy information to be conveyed between the paired and synchronized systems without overt transmission instead using the inherently dependent keystream synchronization process to infer the entropy of the respective keystream.

The amount of entropy that may be added through this mechanism is limited by the number of keystreams, keystream recovery time and minimum simultaneously active keystreams.

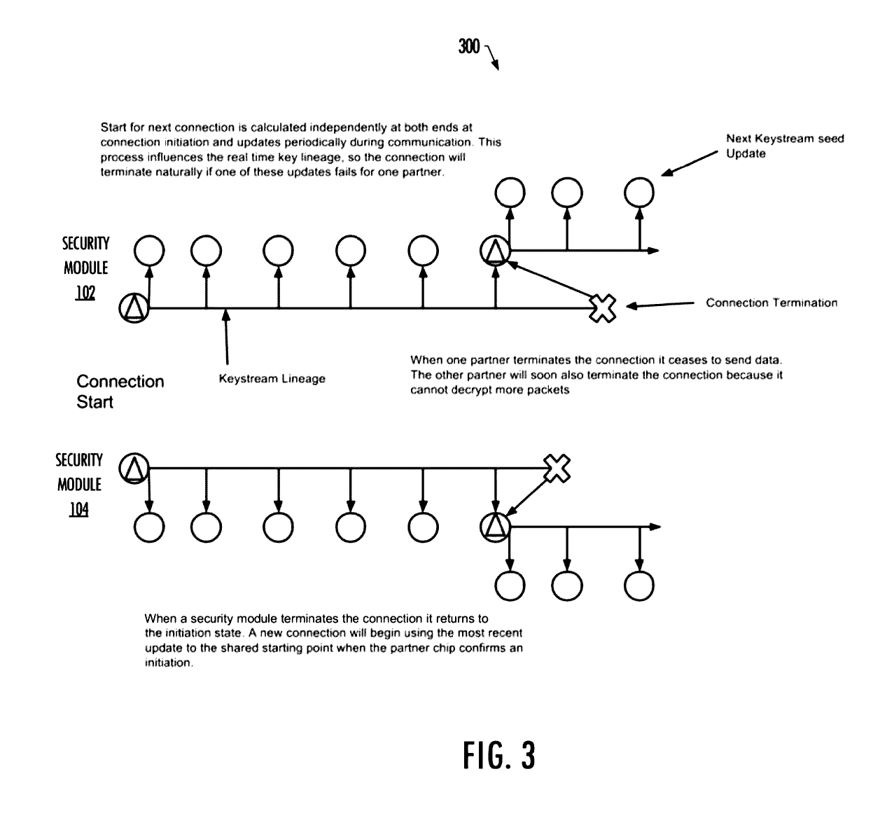

FIG. 3 illustrates a keystream seed update in accordance with an example implementation of the present disclosure. The identical internal states of the paired security modules 102 may be used to generate an encryption security key, packet identifiers, and other values independently at each respective end of the communication pathway that extends through the network 20 between the corresponding computing devices 30. As illustrated, when a connection is established over the network between the computing devices, the security modules may be configured to independently calculate, verify, and store the new security information used for the next connection. The two security modules may initiate a new connection through the network with the same internal state. Similarly, in instances that the connection between the two security modules is interrupted, the two security modules may initiate a reconnection through the network with the same internal state.

In one example implementation, based at least in part on the codependency of security modules 102, a security module may be unable to continue operation without continued verification of decrypted packets originating from the respective paired security module. For example, if one security module experiences a connection failure (e.g., network or physical communications loss, hardware or system failure, or the like) the respective security module may be unable to establish an updated mutually acknowledged starting seed for the next generation of the keystream. However, this may exclude the possibility of a security module losing synchronization beyond the last volatile state.

In some example implementations, the security information for the next connection between the computing devices 30 may be updated periodically by each respective key generator 202 of the security modules 102 during a connection, such that the lineage of security key information may be dependent on connection length of time. The security key information may continue to evolve for the duration that the paired security modules remain connected through the network 20, regardless of whether or not user data is transmitted through the communication pathway that is between computing device and extending through the network. Although, it should be noted that, in some implementations packet and/or data generation may be required to maintain a connected state between paired security modules. In some example implementations, the security module may include an emergency capacitor system to ensure that the security module is able to safely complete writing an update in security information in non-volatile memory in an instance of power loss.

In some implementations, paired security modules 102 may sense when the respective security module is temporarily unavailable, and the security modules may be configured to maintain synchronization of their internal states in the event that the respective security module is temporarily unavailable. For example, the security modules may be configured so that a keep-alive function may constantly monitor the connection status of the computing devices 30 over the network 20, such that a re-initialization is triggered when a break in service is detected. In one example implementation, the keep-alive function may also generate traffic (communication between the computing devices 30 over the network 20) when the amount of data traffic is reduced to maintain a constant and/or required level of traffic to enable a security modules' awareness of the status regarding the respectively paired security module.

In accordance with the aforementioned keep-alive function, control packets referred to at time as keep-alive packets may be generated, and transmitted and received between the computing devices. These packet and other control packets may be identified by appropriate packet identifiers such as Arbitrary Security Group Identifiers (ASGIs), trigger events such as time resets on verification of a successful decryption, and the like. These packets may be interpreted according to their being identified as keep-alive packets without regard to their payload, which may therefore be arbitrary. Or in some examples, the packets themselves may be identified based on their payload, alone or in combination with their packet identifiers.

In one example implementation, the key generator 202 of each security module 102 may include a keystream termination timer configured to continuously count down from a predetermined timeout period. The timer may be configured to reset to a default countdown position each time the security module verifies the successful decryption of any encrypted packet (including both user data or keep-alive packets) originating from the paired security module. As a result, a security module may attempt to reinitialize after data transmission is interrupted for a predetermined duration of time which indicates the respective security module has become unavailable. In one implementation, additional keep-alive packets that contain arbitrarily generated data may be sent between the paired security modules at defined and/or random intervals to maintain the existence of the communication pathway between respective computing devices 30 over the network 20.

In one example implementation, if a security module 102 does not successfully decrypt a packet within an allowed time by the keystream termination timer, the security module may disable the terminated keystream from providing security keys for data packet encryption, destroy the volatile state of the keystream, and change the keystream to the next initiation state for that keystream such that only keep-alive packets may be allowed for encryption through the security information of that key stream until the keystream has been successfully reinitiated allowing both data and keep-alive packets to be encrypted by its security information.

In one example implementation, if there are no keystreams in an active connection state, the security module 102 may be configured to end all communications on a respective private communication interface, thereby only allowing communication on a respective public communications interface while the keystreams attempt to reinitialize. The security module may be configured to continue to loop a first portion of the keystream initialization process until it successfully verifies the decryption of a packet originating from the respective paired security module.

In one example, the security module may be configured to inherently confirm that the security module and the respectively paired security module are in same state as a result of determining that the security module is only capable of decrypting packets encrypted with the security information produced by the next initiation state. In one example implementation, in response to at least one keystream being successfully initialized the device may enable the private communications interface such that data packets can traverse the network 20.

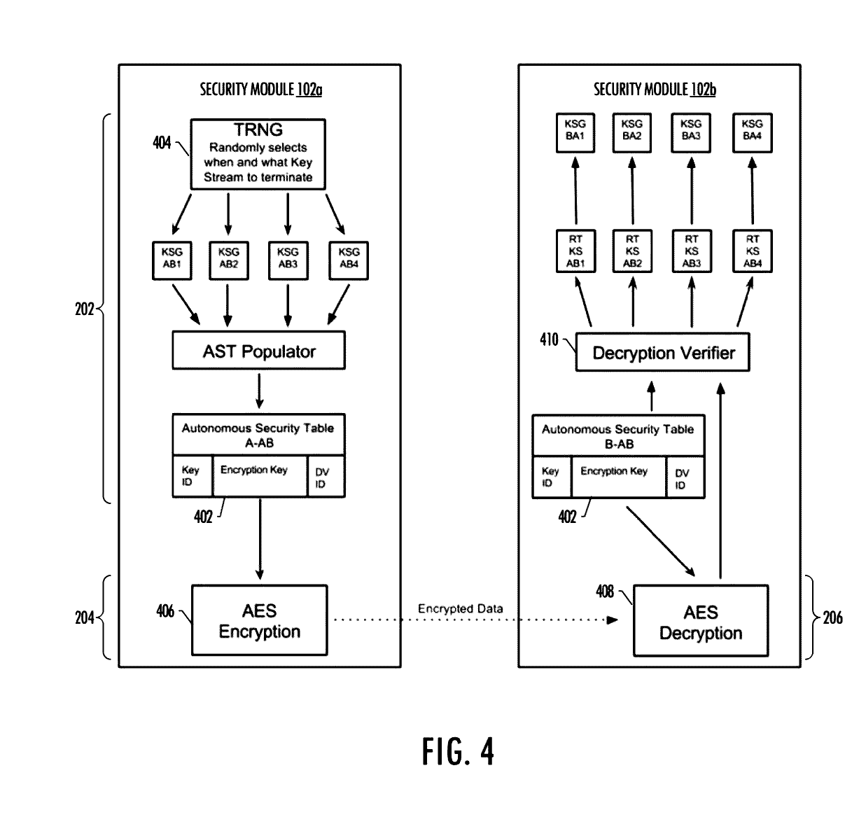

FIG. 4 illustrates paired first and second security modules 102a, 102b that implementing respectively data encryption and data decryption, according to example implementations. It should be noted that although the example implementation of FIG. 4 illustrates the first and second security modules having components particular to respectively data encryption and data decryption, either or both of the paired security modules may include the components for both data encryption and data decryption such that the security module(s) may perform both data encryption and data decryption. Accordingly reference to the paired security modules 102 may refer to either or both of the paired first and second security modules.

In some example implementations, security modules may be manufactured and paired together by programming two security modules with identical random seed information. The security modules may be programmed with random number information for each variable in the security key generation and related functions. As shown, the paired first and second security modules 102a, 102b may be programmed to have corresponding autonomous security tables 402. The paired security modules may be initialized and/or programmed with identical true random seed information generated by an outside programming system and/or created through a shared initialization process facilitated by a physically-connected computing device 30.

In one implementation, the first security module 102a includes a random number generator 404, keystream generators (KSGs) 406 and arbitrary security table (AST) populator 408 that, along with the autonomous security table 402, may be one example of the key generator 202 of FIG. 2. KSG's are the keystream generators, PRNG architecture for generating encryption keys, DVID's, and the like. The AST populator uses a deterministic process to assign ASGI's to security groups to prevent the ASGI's from being associated with particular keystreams should their lineage be determined. The random number generator may be configured to iterate in step as data is transmitted, thereby enabling each of the paired first and second security modules to maintain synchronized security key information.

In one example implementation, the paired first and second security modules 102a, 102b may include an encryption engine 406 that may be one example of the encryption engine 204 of FIG. 2. The encryption engine may operate based at least in part on a security key-based encryption scheme according to AES. The encryption engine may be configured to encrypt outgoing packet data and append the outgoing packet data with any information necessary for processing at the packet's destination. The security module may comprise two instances of the security key-generation and encryption circuitry to independently handle up-stream and down-stream data.

In one example implementation, after encrypting the packet data and appending the outgoing packet data with any information necessary for processing at the packet's destination, the first security module 102a may append internet protocol (IP) routing information to the subject packet to direct it to the paired second security module 102b. The first security module may be configured to facilitate acquiring the IP information of the paired second security module in a number of manners. In one example, if both security modules are installed in areas where the network topography will remain static, each of the paired security modules may be configured with the respective module's IP address and potentially machine access control (MAC) address, as well as the IP address and potentially MAC address of the other of the paired security modules. In an instance in which both of the security modules are mobile, a server and/or in a dynamic environment, each of the paired security modules may be provided with its IP address and potentially MAC address, and the location of a mutual dynamic association server from which the security module may obtain the IP address and potentially MAC address of the other of the paired security modules.

In one example implementation, in which the first security module 102a is a dynamic security module, the first security module may be configured to contact the server to update its address information when attempting to establish a new connection. In such an implementation, the first security module may continue to update the its address information until it establishes a connected state. The server may hold the address information for a predetermined period of time until it has not received a recent update and/or the paired second security module 102b updates the server with its respective address information allowing the server to inform each security module of the address information for the respectively paired second security module. In some example implementations, this information may have no relation to the security of the data such that no secure data may pass between the security modules while communicating with the server.

In one example implementation, the paired second security module 102b may include a decryption engine 408 that may be one example of the decryption engine 206 of FIG. 2. The decryption engine may operate based at least in part on a security key-based encryption scheme according to AES. In one example implementation, packets being transmitted from the first security module 102a to the second security module may take time to arrive at the destination and may not necessarily arrive in order.

Accordingly, in one example implementation, in order to match each packet with the correct decryption security key, the decryption engine 408 may utilize a buffer of the most recently generated security keys. Each position in the buffer may be correlated with a randomly and arbitrarily assigned dynamic identifier such as an ASGI, and an associated arbitrary and randomly generated verification sequence such as a decryption verification identifier (DVID). The assigned identifier may be added to the unencrypted section of each packet sent through the network 20 and matched at the destination. In one example in which the information may be added to the packets causes the packet size to exceed the default maximum packet size, the information may be split up into separate smaller packets that may be reassembled when received at the destination.

In one implementation, the paired second security module 102b may include a decryption verifier 410. The decryption verifier may be configured to decrypt and verify data encrypted with security keys generated based on random numbers. Accordingly, the decryption verifier may identify information such as a security module identifier, and/or other variables/information that may be only known to each of the paired security modules. The paired security modules may be configured to verify expected information to authenticate the connection between them without sending information used to define the security keys, system information or state of the security modules.

In one implementation, the decryption verification process executed by the decryption verifier 410 may be implemented according to a similar principle utilized for the generation of the security keys. The paired first and second security modules 102a, 102b may be configured such that a unique, random and arbitrary sequence of bits (e.g., verification bits) may be generated for each packet being transmitted through the secured communication system 100 and may be appended to that packet's data prior to encryption. As a result, when the packet reaches its destination, the decryption verifier at the destination (e.g., the second security module) may be configured such that the packet is decrypted and the verification bits are checked against the sequence generated using the same process at the destination. In one example implementation, the packet's data may not be allowed to leave the second security module unless these sequences match.

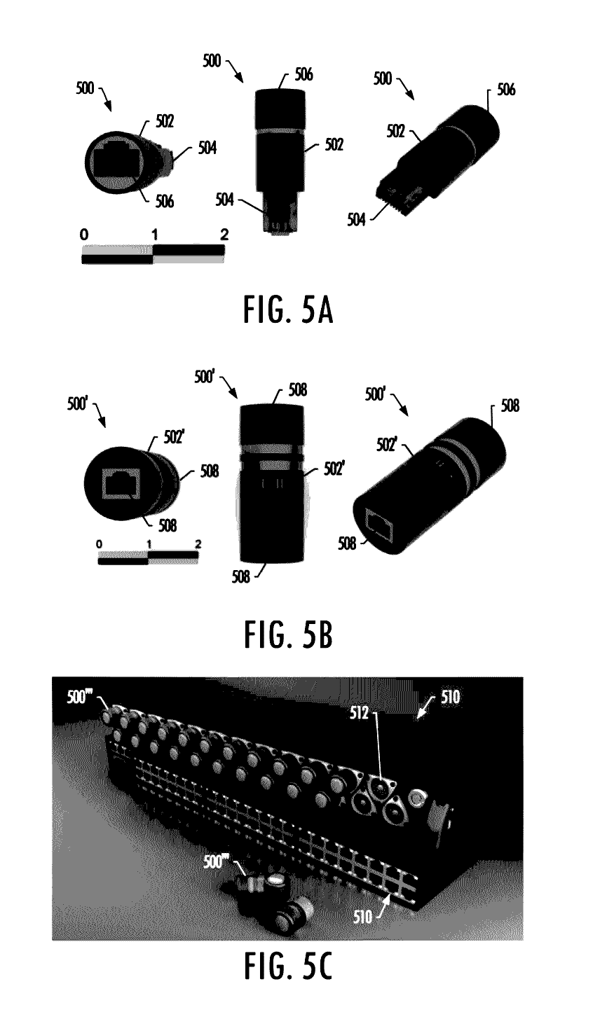

As indicated above, in some example implementations, one or more communication interfaces 40 and security module 102 may be integrated into a single apparatus. FIG. 5A illustrates an apparatus 500 including a housing 502 that encloses the security module including the circuitry (e.g., ASIC) that embody it. On either end of the housing is a respective communication interface coupled to the security module therein. One of the communication interfaces is configured to couple the security module to a computing device 30, and the other is configured to couple the computing device with the security module to another computing device over one or more networks 20. In some examples, these communication interfaces may include appropriate connectors such as plugs and ports. As shown in FIG. 5A, the apparatus includes an Ethernet plug 504 that may be received by a corresponding Ethernet port of a computing device, and an Ethernet port 506 that may receive an Ethernet plug via which the apparatus may be coupled to an appropriate network router, modem or the like.

FIG. 5B illustrates a similar apparatus 500′ including a housing 502′ that encloses the security module 102. And on either end of the housing, the apparatus includes a respective communication interface. The communication interfaces in this example include a pair of telephone ports 508 that may receive respective telephone plugs via which the apparatus may be coupled to a computing device and appropriate network router, modem or the like.

FIG. 5C illustrates yet another example including an accumulator 510 that houses a number of apparatuses 500″ in a rack-mountable device for easier management of multiple links (possibly at different physical locations and network addresses) in one physical location. Each of these apparatuses also include a housing for a security module, and a plug to couple the apparatus to the accumulator. For each of the apparatuses, the accumulator may include a port 512 in which the apparatus may be plugged, and a pair of ports 514 that may be connected to a computing device 30 and network router, modem or the like.

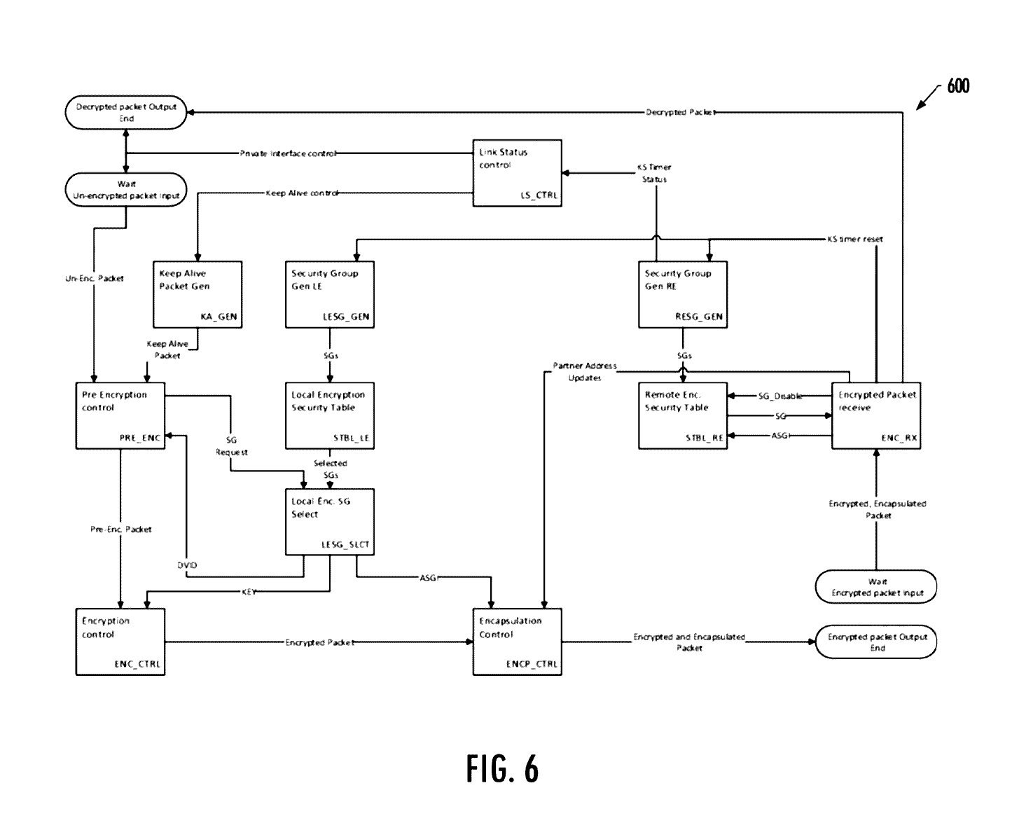

FIG. 6 illustrates a more particular functional block diagram 600 of a security module 102, according to some example implementations. As illustrated, the security module may include various components configured to implement one or more functions discussed herein. In one example implementation, in response to being powered and detecting a physical public interface link, the security module may be configured to initialize the generation of keep-alive packets, and initialize local to remote and remote to local security group generators from previously saved seed data. Each of the paired security modules may begin decrypting the other's encrypted keep-alive packets and initialize their respective last successful decryption timers.

In one example implementation, if the timers are collectively reset to allow continued operation of security group generation for the initialization period, the status controller enables the private communication interface, and private packets may be allowed to enter and leave the security module. The security module 102 may continue to generate keep-alive packets at a lower rate as the security group generation continues. In one example, when an unencrypted packet from the private communications interface is received it may be encrypted and sent out the public communications interface. In another example, when an encrypted packet on the public communication interface is received it may be decrypted and output to the private communications interface or dropped if it cannot be successfully validated. If validation is successful the key stream timers may be reset accordingly allowing the system to continue operating.

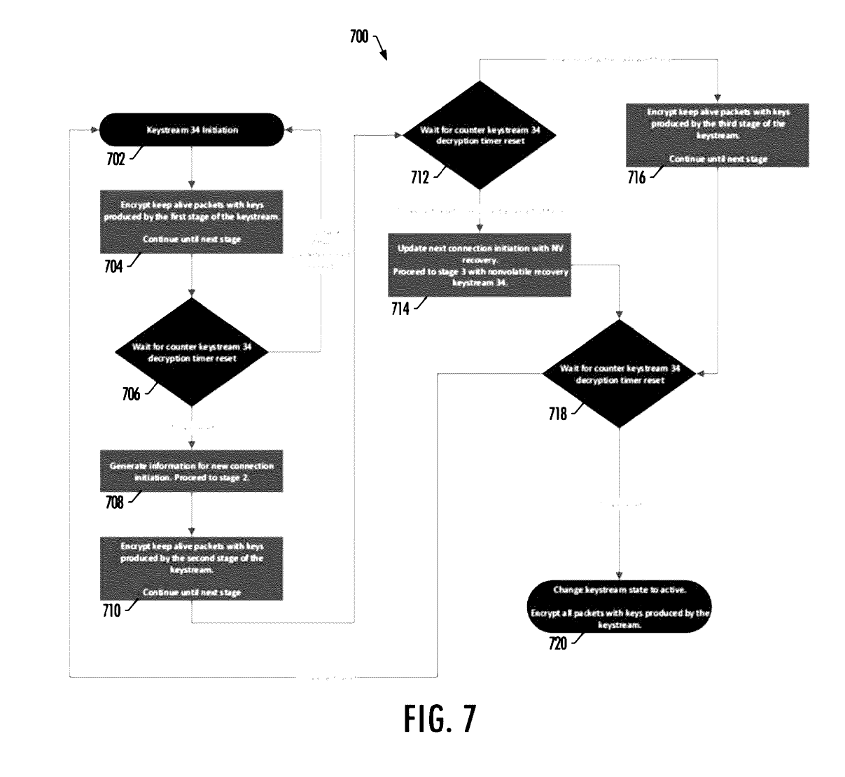

Reference will now be made to FIGS. 7, 8 and 9 which illustrate methods for providing synchronized hardware-based security for a communication system, in accordance with example implementations of the present disclosure.

FIG. 7 illustrates a flowchart including operations in a method 700 of initiating a connection for data transmission, in accordance with an example implementation of the present disclosure. As shown at step 702, the method may include initializing a key stream. The method may also include encrypting keep-alive packets with keys produced by the first stage of the keystream, as shown at step 704. At step 706, the method may include waiting for a counter of a keystream decryption time to reset, during which the method may resume step 702 after a predetermined period of time. After the timer has reset, the method may include generating information for initiating a new connection, as shown at step 708. The method may also include encrypting keep-alive packets with keys produced by the second stage of the keystream, as shown at step 710. At step 712, the method may include waiting for a counter of a keystream decryption time to reset. If the timer is not reset within an allotted time, the method may include updating the next connection initiation with a non-volatile recovery, as shown at step 714. Alternatively, if the timer is reset within an allotted time, the method may include encrypting keep-alive packets with keys produced by the third stage of the keystream, as shown at step 716. At step 718, the method may include waiting for a counter of the keystream decryption time to reset, during which the method may resume step 702 after a predetermined period of time. After the timer has reset, at step 720, the method may include changing the keystream state to active, and encrypting all of the packets with keys produced by the keystream.

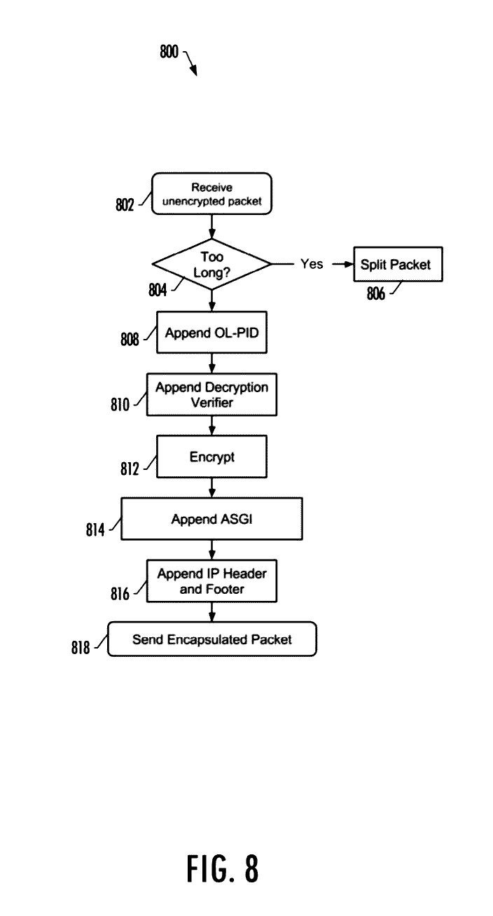

FIG. 8 illustrates a flowchart including operations in a method 800 of data encryption, in accordance with an example implementation of the present disclosure. As shown at step 802, the method may include receiving an unencrypted packet. The method may also include determining whether or not the received packet is too long, as shown at step 804. If the received packet is too long, the method may include splitting the receiving packet, as shown at step 806. The method may include appending packet identification information and a decryption verifier to the packet, as shown at steps 808, 810, respectively. As shown at step 812, the method may include encrypting the packet. The method may include appending an arbitrary security group identifier and an IP header and footer to the packet, as shown at steps 814, 816, respectively. The method may include sending the encapsulated packet, as shown at step 818.

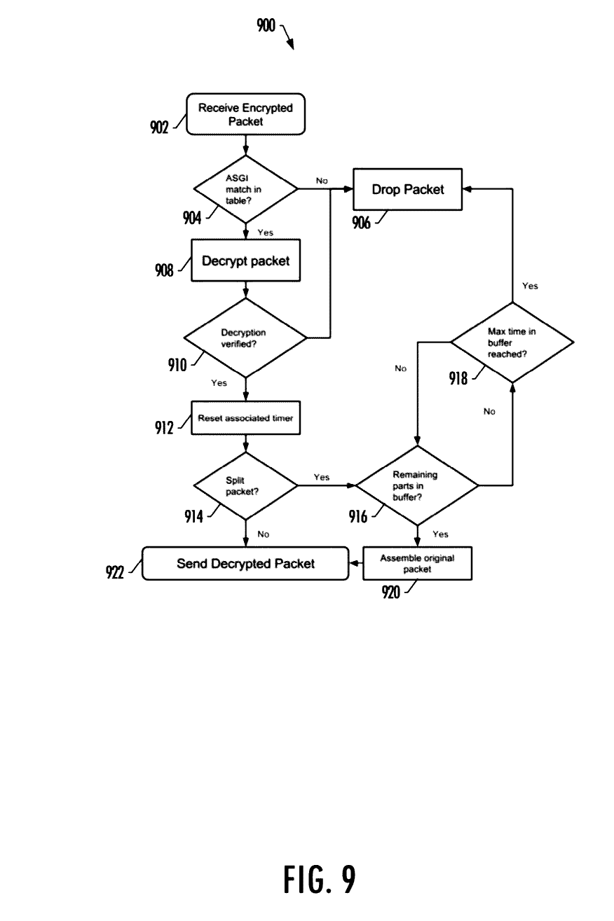

FIG. 9 illustrates a flowchart including operations in a method 900 of data decryption, in accordance with an example implementation of the present disclosure. As shown at step 902, the method may include receiving an encrypted packet. The method may also include determining whether or not a match exists for the arbitrary security group identifier, as shown at step 904. If a match does not exist, the method may include dropping the packet, as shown at step 906. If a match does exist, the method may include decrypting the packet, as shown at step 908. The method may also include determining whether or not the decryption is verified, as shown at step 910. If the decryption is not verified, the method may include dropping the packet, as shown at step 906. If the decryption is verified, the method may include resetting an associated timer, as shown at step 912. The method may also include determining whether or not the packet has been split, as shown at step 914. If the packet has been split, the method may include determining whether or not any remaining portions of the packet are in the buffer, as shown at step 916. If no remaining portions are in the buffer, the method may include determining if the maximum time in the buffer has been reached, as shown at step 918. If the maximum time in the buffer has been reached, the method may include dropping the packet, as shown at step 906. If the system determines there are remaining portions of the split packet in the buffer, the method may include assembling the original packet, as shown at step 920. As shown at step 922, after the original packet has been assembled or the system has determined the packet was not split, the method may include sending the decrypted packet.

According to example implementations of the present disclosure, the secured communication system 100, and more particularly the security modules 102 and their subsystems and/or components including the key generator 202, encryption engine 204, and/or decryption engine 206, may be implemented by various means. Means for implementing the systems, subsystems and their respective elements may include hardware, alone or under direction of one or more computer programs from a computer-readable storage medium.

In some examples, one or more apparatuses may be provided that are configured to function as or otherwise implement the systems, subsystems, tools and respective elements shown and described herein. In examples involving more than one apparatus, the respective apparatuses may be connected to or otherwise in communication with one another in a number of different manners, such as directly or indirectly via a wired or wireless network or the like.

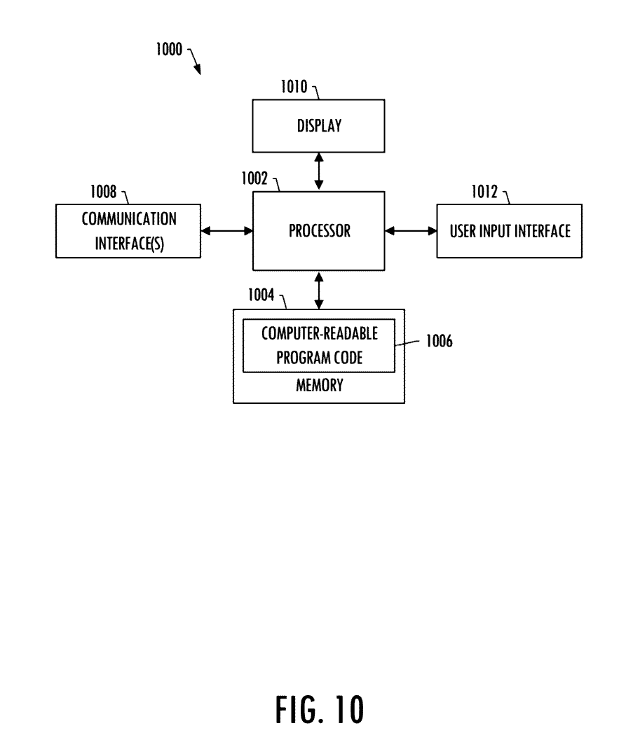

FIG. 10 illustrates an apparatus 1000 according to some example implementations of the present disclosure. Generally, an apparatus of example implementations of the present disclosure may comprise, include or be embodied in one or more fixed or portable electronic devices. Examples of suitable electronic devices include a smartphone, tablet computer, laptop computer, desktop computer, workstation computer, server computer, automated teller machine (ATM), or the like. The apparatus may include one or more of each of a number of components such as, for example, a processor 1002 (e.g., processor unit) connected to a memory 1004 (e.g., storage device).

The processor 1002 is generally any piece of computer hardware that is capable of processing information such as, for example, data, computer programs and/or other suitable electronic information. The processor is composed of a collection of electronic circuits some of which may be packaged as an integrated circuit or multiple interconnected integrated circuits (an integrated circuit at times more commonly referred to as a “chip”). The processor may be configured to execute computer programs, which may be stored onboard the processor or otherwise stored in the memory 1004 (of the same or another apparatus).

The processor 1002 may be a number of processors, a multi-processor core or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more specific-purpose integrated circuits such as one or more ASICs, field-programmable gate arrays (FPGAs) or the like. Thus, although the processor may be capable of executing a computer program to perform one or more functions, the processor of various examples may be capable of performing one or more functions without the aid of a computer program.

The memory 1004 is generally any piece of computer hardware that is capable of storing information such as, for example, data, computer programs (e.g., computer-readable program code 1006) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk—read only memory (CD-ROM), compact disk—read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 1004, the processor 1002 may also be connected to one or more interfaces for displaying, transmitting and/or receiving information. The interfaces may include a communications interface 1008 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links.

These wireless communication links in particular may be configured to implement any of a number of different radio access technologies such as any of a number of 3GPP or 4GPP radio access technologies, UMTS UTRA, GSM radio access technologies, CDMA 2000 radio access technologies, WLANs (e.g., IEEE 802.xx, e.g., 802.11a, 802.11b, 802.11g, 802.11n), WiMAX, IEEE 802.16, wireless PANs (WPANs) (e.g., IEEE 802.15, Bluetooth®, low power versions of Bluetooth®, IrDA, UWB, Wibree, Zigbee®), near-field communication technologies, and the like. Examples of suitable communication interfaces include a network interface controller (NIC), wireless NIC (WNIC), infrared interfaces, laser interfaces, light based interfaces, vibration interfaces, other wireless forms of data transmissions, body area networks, local area networks, conductors embodied by a human body, or the like.

The communication interface 1008 may be configured to enable a computing device (e.g., computing device 30) to communicate with one or more other computing devices. In this regard, the communication interface 1008 may include one or more interface mechanisms for enabling communication with other devices and/or networks. As such, the communication interface 1008 may include, for example, an antenna (or multiple antennas) and supporting hardware and/or software for enabling communications with a wireless communication network (e.g., a cellular network, WLAN, and/or the like) and/or a communication modem or other hardware/software for supporting communication via cable, digital subscriber line (DSL), USB, FireWire, Ethernet or other wired networking methods. As such, the communication interface 1008 of some exemplary embodiments may be configured to support communications over one or more networks (e.g., network 20). In accordance with the exemplary embodiment, the communication interface 1008 may be or include at least one security module (e.g., security module 200).

The user interfaces may include a display 1010 and/or one or more user input interfaces 1012 (e.g., input/output unit). The display may be configured to present or otherwise display information to a user (technician), and in some examples may include the display device of a wearable (e.g., head-mounted) or handheld personal display system. Examples of suitable personal display systems may include private, private-shared (linked private) or public personal display systems such as those provided in the form of eyeglasses, safety goggles, contact lenses and the like, image projectors, video projectors, any of a number of other active or passive display systems, laser pointers and the like. In other examples, the display device may include a more conventional display device such as a liquid crystal display (LCD), light-emitting diode display (LED), plasma display panel (PDP) or the like, which may or may not take the form of a personal display system (e.g., smartphone, tablet computer).

The user input interfaces 1012 may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by a processor, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. In this manner, an apparatus 1000 may include a processor 1002 and a computer-readable storage medium or memory 1004 coupled to the processor, where the processor is configured to execute computer-readable program code 1006 stored in the memory. It will also be understood that one or more functions, and combinations of functions, may be implemented by special purpose hardware-based computer systems and/or processors which perform the specified functions, or combinations of special purpose hardware and program code instructions.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the present invention. Moreover, although the foregoing description and the associated drawings describe example implementations in the context of certain example combinations of elements and/or functions, it should be appreciated that different combinations of elements and/or functions may be provided by alternative implementations without departing from the scope of the present invention. In this regard, for example, different combinations of elements and/or functions than those explicitly described above are also contemplated. Although specific terms are employed herein, they are used in a generic and descriptive sense only and not for purposes of limitation.

What is claimed is:

1. An apparatus comprising:
a housing enclosing one or more integrated circuits comprising:
a memory configured to store a pre-configured state of the one or more integrated circuits, the pre-configured state being identical to the pre-configured state of another apparatus with which the apparatus is paired; and
one or more processor cores configured to access the memory and execute a cipher in accordance with the pre-configured state; and
a first communication interface and a second communication interface each of which is physically coupled to the housing and communicatively coupled to the one or more integrated circuits,
wherein the first communication interface is communicatively coupleable to a first network node, the second communication interface is communicatively coupleable to an insecure network between the first network node and a second network node to which the other apparatus is communicatively coupleable, and the one or more processor cores are configured to execute the cipher to implement a security service for data carried by the insecure network between the first network node and second network node.
